(19) United States
(12) Patent Application Publication
(10) Pub. No.: US 2013/0322690 A1
(43) Pub. Date: Dec. 5, 2013

(54) SITUATION RECOGNITION APPARATUS AND METHOD USING OBJECT ENERGY INFORMATION

(71) Applicant: Electronics and Telecommunications Research Institute, Daejeon (KR)

(72) Inventors: Chang Eun LEE, Daejeon (KR); Hyun Kyu CHO, Daejeon (KR); Sung Hoon KIM, Daejeon (KR)

(73) Assignee: Electronics and Telecommunications Research Institute, Daejeon (KR)

(21) Appl. No.: 13/902,886

(22) Filed: May 27, 2013

(30) Foreign Application Priority Data
Jun. 4, 2012 (KR) 10-2012-0059924

(51) Int. Cl. G06K 9/32

(52) U.S. Cl. CPC G06K 9/3241
USPC 382/103

(57) ABSTRACT

A situation recognition apparatus and method analyzes an image to convert a position and motion change rate of an object in a space and an object number change rate into energy information, and then changes the energy information into entropy in connection with an entropy theory of a measurement theory of a disorder within a space. Accordingly, the situation recognition apparatus and method recognizes an abnormal situation in the space and issues a warning for the recognized abnormal situation. Therefore, the situation recognition apparatus and method recognizes an abnormal situation within a space, thereby effectively preventing or perceiving a real-time incident at an early stage.

### CROSS-REFERENCE TO RELATED APPLICATION(S)

The present invention claims priority of Korean Patent Application No. 10-2012-0059924, filed on Jun. 4, 2012, which is incorporated herein by reference.

### FIELD OF THE INVENTION

The present invention relates to an apparatus and method for recognizing a situation within a space using object energy information extracted by analyzing an image.

### BACKGROUND OF THE INVENTION

As is well known, a place such as a prison or power plant requires continuous monitoring. Accordingly, a mobile unmanned patrol robot and a remote control system are utilized to monitor a number of spaces. For example, in a prison, they can prevent or discover various incidents such as suicides, violence, arson, and damage to property through continuous monitoring at an early stage.

As a conventional technique for monitoring a space using an image, Korean Patent No. 1018418 (Feb. 22, 2011) has disclosed a system and method for monitoring an image.

The system and method for monitoring an image includes a field device, a network, and a management device.

The field device is installed in a sensitive area of a power plant where continuous monitoring is required and access is not easy, and collects images of a predetermined monitoring area.

The management device stores the images collected by the field device, analyzes motion to determine whether or not an emergent situation has occurred depending on whether the motion is a simple motion or a defined motion of interest, and issues an alarm so that an initial countermeasure can be taken.

The network connects the field device and the management device to transmit and receive data.

The system configured in such a manner continuously monitors a vulnerable area of the power plant in which continuous monitoring is difficult to perform and to which a monitoring worker cannot have access. Furthermore, when an emergent situation, such as an oil leak, fire, or smoke, is detected in a monitoring area, the system may take a rapid initial countermeasure.

For this operation, the system continuously monitors a high-temperature and high-pressure oil system and a vulnerable area in the power plant. Furthermore, the system recognizes oil leakage, fire, or smoke through image analysis, thereby improving the quality of monitoring management. Furthermore, the system measures a movement signal of a camera, utilizes the measured movement signal in the image analysis and control, and takes a rapid initial countermeasure when an incident occurs.

However, the conventional system and method for monitoring an image cannot recognize an object when an image is acquired using a 2D camera. Even if the object is partially recognized, performance cannot he guaranteed when the recognized information is converted into spatial energy. Furthermore, a method for measuring spatial energy through a rate of change of color may be used. However, the precision of the method is not as high as expected.

### SUMMARY OF THE INVENTION

In view of the above, the present invention provides a situation recognition apparatus and method that analyzes an image to convert the position and motion of an object and an object number change rate within a space into energy information, and recognizes an abnormal, situation in connection with entropy theory. According to the present invention, it is possible to prevent or discover various incidents at an early stage so as to quickly and accurately identify a situation in a monitoring space such as a prison.

In accordance with an aspect of the exemplary embodiment of the present invention, there is provided a situation recognition apparatus using object energy information, which includes: an image receiving unit for receiving a taken image; an object detection unit for detecting an object by analyzing the received image; an object position information extraction unit for extracting position information with the image for the detected object; an object motion information extraction unit for extracting motion information within the image for the detected object; an object number change rate measurement unit for measuring an object number change rate within the image for the detected object; an entropy calculation unit for converting a position change rate of the object, measured based on the position information, a motion change rate of the object, measured based on the motion information, and the object number change rate into energy information, and measuring entropy of the converted energy information; and a situation recognition unit for recognizing a situation within a space where the image was taken by associating a change rate of the entropy measured within the image with a risk policy.

In the exemplary embodiment, wherein the object detection unit detects multiple objects, and the entropy calculation unit converts the position change rate, measured for the multiple objects, and the motion change rate, measured for each of the objects, into the energy information.

In the exemplary embodiment, further comprising a weight applying unit for applying a weight to one or more of the position change rate of the object, the motion change rate of the object, and the object number change rate, wherein the entropy calculation unit measures the entropy based on the weight.

In the exemplary embodiment, wherein the weight applying unit applies the weight based on a reference value stored in a database for each environment in the space where the image was taken.

In the exemplary embodiment, further comprising a normalization unit for normalizing the position change rate of the object, the motion change rate of the object, and the object number change rate and transmitting the normalized rates to the weight applying unit.

In accordance with another aspect of the exemplary embodiment of the present invention, there is provided a situation recognition method using object energy information, which includes: receiving a taken image; detecting an object by analyzing the received image; extracting position information within the image for the detected object; extracting motion information within the image for the detected object; measuring an object number change rate within the image for the detected object; converting a position change rate of the object, measured based on the position information, a motion change rate of the object, measured based on the motion information, and the object number change rate into energy information, and measuring entropy of the converted energy information; and recognizing a situation within a space where the image was taken by associating a change rate of the entropy measured within the image with a risk policy.

In the exemplary embodiment, wherein the detecting the object comprises detecting multiple objects, and the measuring the entropy comprises converting the position change rate measured for the multiple objects and the motion change rate measured for each of the objects into the energy information.

In the exemplary embodiment, further comprising applying a weight to one or more of the position information rate of the object, the motion change rate of the object, and the object number change rate, wherein the measuring the entropy comprises measuring the entropy based on the weight.

In the exemplary embodiment, wherein the applying the weight comprises applying the weight based on a reference value stored in a database for each environment in the space where the image was taken.

In the exemplary embodiment, further comprising normalizing the position change rate of the object, the motion change rate of the object, and the object number change rate, and then applying the weight.

### BRIEF DESCRIPTION OF THE DRAWINGS

The objects and features of the present invention will become apparent from the following description of embodiments given in conjunction with the accompanying drawings, in which:

FIG. 1 is a block configuration diagram of a situation recognition apparatus using object energy information in accordance with an embodiment of the present invention;

FIG. 2 is a flowchart for explaining a situation recognition method using object energy information in accordance with another embodiment of the present invention; and

### DETAILED DESCRIPTION OF THE EMBODIMENTS

The advantages and features of embodiments and methods of accomplishing the present invention will be clearly understood from the following described description of the embodiments taken in conjunction with the accompanying drawings. However, the present invention is not limited to those embodiments and may be implemented in various forms. It should be noted that the embodiments are provided to make a full disclosure and also to allow those skilled in the art to know the full range of the present invention. Therefore, the present invention will, be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

Hereinafter, embodiments of the present invention will be described in detail with reference to the accompanying drawings, which form a part hereof.

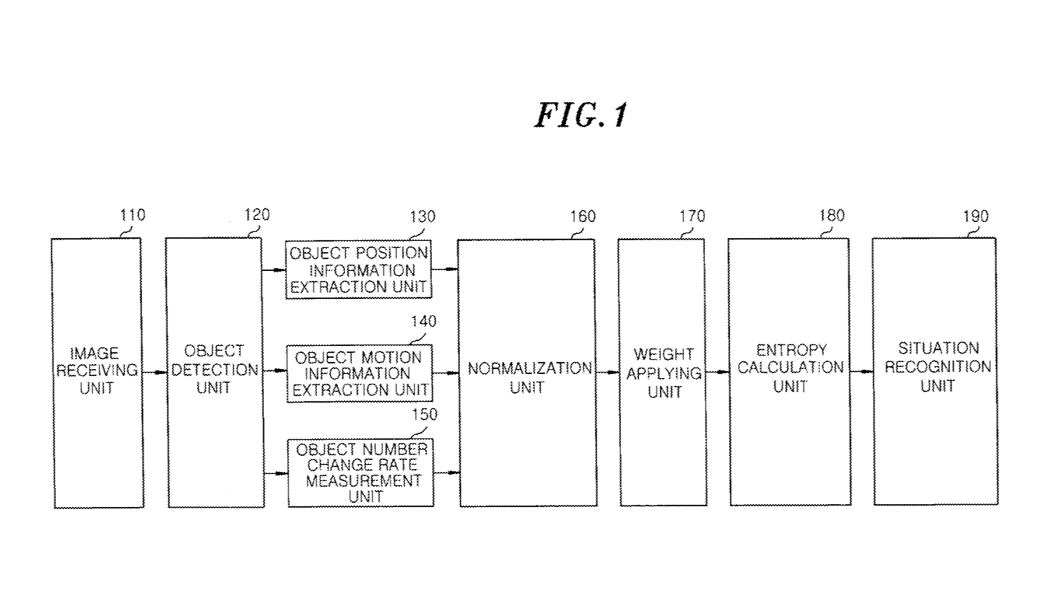

FIG. 1 is a block configuration diagram of a situation recognition apparatus using object energy information in accordance with an embodiment of the present invention.

Referring to FIG. 1, the situation recognition apparatus includes an image receiving unit 110, an object detection unit 120, an object position information extraction unit 130, an object motion information extraction unit 140, an object number change rate measurement unit 150, a normalization unit 160, a weight applying unit 170, an entropy calculation unit 180, and a situation recognition unit 190.

The image receiving unit 110 is configured to receive an image taken in a monitoring space. For example, the image receiving unit 110 may receive a 3D monitoring image taken with a 3D camera. Furthermore, the image receiving unit 110 may improve the quality of the image by removing noise through pre-processing of the received image information.

The object detection unit 120 is configured to detect an object by analyzing the image received through the image receiving unit 110. For example, the object detection unit 120 may detect multiple objects from the image.

The object position information extraction unit 130 is configured to extract position information within the image for the object detected by the object detection unit 120.

The object motion information extraction unit 140 is configured to extract motion information within the image for the object detected by the object detection unit 120.

The object number change rate measurement unit 150 is configured to measure an object number change rate within the image for the object detected by the object detection unit 120.

The normalization unit 160 is configured to normalize the position information extracted by the object position information extraction unit 130, the motion information extracted by the object motion information extraction unit 140, and the object number change rate measured by the object number change rate measurement unit 150, and transmit the normalized information to the weight applying unit 170.

The weight applying unit 170 is configured to apply a weight to one or more of the normalized position information, the normalized motion information, and the normalized object number change rate, in order to update the respective pieces of information. For example, the weight applying unit 170 may apply a weight based on a reference value stored in database for each environment in the space where the image was taken.

The entropy calculation unit 180 is configured to calculate the entropy in the monitoring space based on noise distribution within the image. For example, the entropy calculation unit 180 converts position change rates of multiple objects, measured based on the position information, a motion change rate of each of the objects, measured based on the motion information, and the object number change rate into energy information, and then measures the entropy of the converted energy information. That is, main factors of the entropy measurement may include the position change rates of the multiple objects and the motion change rate of each of the objects.

The situation recognition unit 190 is configured to recognize a situation in the space by associating the entropy change rate within the image, calculated by the entropy calculation unit 180 with a risk policy.

The situation recognition apparatus in accordance with the embodiment of the present invention may further include the normalization unit 160 and the weight applying unit 170, in order to accurately and quickly recognize an abnormal situation. In another embodiment, the situation recognition apparatus may be configured in such a manner that the normalization unit 160 and the weight applying unit 170 are excluded.

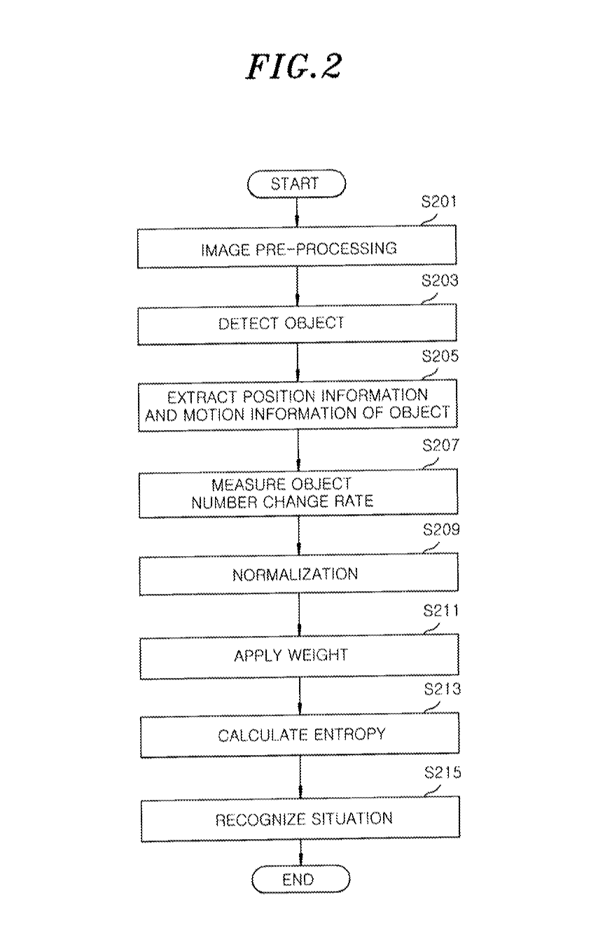

FIG. 2 is a flowchart for explaining a situation recognition method using object energy information in accordance with another embodiment of the present invention.

Referring to FIGS. 1 and 2, the situation recognition method based on the situation recognition apparatus in accordance with the embodiment of the present invention will be described.

First, the image receiving unit 110 receives an image taken of a monitoring space. For example, the image receiving unit 110 may receive a 3D monitoring image taken with a 3D camera. Furthermore, the image receiving unit 110 may remove noise through pre-processing of the received image information, thereby improving the quality of the image, at step S201. The image pre-processor may be applied to improve the quality of the received image information and remove noise. For example, the image pre-processor may remove noise caused by a change rate of internal or external motion, rather than a person's motion, when the motion occurs, or may uniformize the change of an image depending on illumination and light intensity.

Then, the object detection unit 120 detects an object by analyzing the image received through the image receiving unit 110. For example, the object detection unit 120 may detect multiple objects in the image at step S203.

Then, the object position information extraction unit 130 extracts position information within the image for the object detected by the object detection unit 120.

Furthermore, the object motion information extraction unit 140 extracts motion information within the image for the object detected by the object detection unit 120 at step S205.

Furthermore, the object number change rate measurement unit 150 measures an object number change rate within the image for the object detected by the object detection unit 120 at step S207.

The normalization unit 160 normalizes the position information extracted by the object position information extraction unit 130, the motion information extracted by the object motion information extraction unit 140, and the object number change rate measured by the object number change rate measurement unit 150, and transmits the normalized information to the weight applying unit 170 at step S209.

Then, the weight applying unit 170 applies a weight to one or more of the normalized position information, the normalized motion information, and the normalized object number change rate, in order to update the respective pieces of information. For example, the weight applying unit 170 may apply a weight based on a reference value stored in a database for each environment in the space where the image was taken, at step S211.

Then, the entropy calculation unit 180 calculates the entropy in the monitoring space based on noise distribution within the image. For example, the entropy calculation unit 180 converts position change rates of multiple objects, measured based on the position information, a motion change rate of each of the objects, measured based on the motion information, and the object number change rate into energy information, and then measures the entropy of the converted energy information at step S213. That is, main factors of the entropy measurement may include the position change rates of the multiple objects and the motion change rate of each of the objects.

Then, the situation recognition unit 190 recognizes the situation in the space by associating the entropy change rate within the image calculated by the entropy calculation unit 180 with a risk policy, at step S215.

In the above-described situation recognition apparatus and method, when a motion occurs in a space, much noise may occur in this space. At this time, the region in which a person is present and no motion occurs may be determined to be a region in which noise and change on the screen are small. Furthermore, when energy is low, it may indicate that a small number of motions occur. Based on such characteristics, high entropy is measured in a space where monitoring is required or a problem has occurred. Depending on the measured entropy, a dangerous situation may be recognized. That is, based on noise distribution in the space, the entropy of the region may be calculated to recognize a dangerous situation.

As described above, the main factors of the entropy measurement may include the position change rates of multiple objects and the motion change rate of each object. For example, a prison, the basic entropy of the residential zone of prisoners is stable. However, when the position of a prisoner rapidly changes or a specific user rapidly moves, the change or motion may cause a change in entropy. Furthermore, the system and method may recognize a violent or dangerous situation by associating the change rate of the entropy with a risk policy, thereby issuing a warning to a control system.

In accordance with embodiments of the present invention, the situation recognition apparatus and method may analyze an image to convert a position and motion change rate of an object in a space and an object number change rate into energy information, and then changes the energy information into entropy in connection with an entropy theory of a measurement theory of a disorder within a space. Accordingly, the situation recognition apparatus and method may recognize an abnormal situation in the space and issue a warning for the recognized abnormal situation. Therefore, the situation recognition apparatus and method may recognize an abnormal situation within a space, thereby effectively preventing or perceiving a real-time incident at an early stage.

The combinations of the each block of the block diagram and each operation of the flow chart may be derived from computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in computer readable memory or a memory usable in a computer which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions derived from the computer or programmable data processing equipment may provide the operations for executing the functions described in the each block of the block diagram and each operation of the flow chart by a series of functional operations being performed on the computer or programmable data processing equipment, thereby a process executed by a computer being generated.

The explanation as set forth above is merely described a technical idea of the exemplary embodiments of the present invention, and it will he understood by those skilled in the art to which this invention belongs that various changes and modifications may be made without departing from the scope of the essential characteristics of the embodiments of the present invention. Therefore, the exemplary embodiments disclosed herein are not used to limit the technical idea of the present invention, but to explain the present invention, and the scope of the technical idea of the present invention is not limited to these embodiments. Therefore, the scope of protection of the present invention should be construed as defined in the following claims and changes, modifications and equivalents that fall within the technical idea of the present invention are intended to be embraced by the scope of the claims of the present invention.

What is claimed is:

1. A situation recognition apparatus using object energy information, comprising:
an image receiving unit configured to receive a taken image;
an object detection unit configured to detect an object by analyzing the received image;
an object position information extraction unit configured to extract position information with the image for the detected object;
an object motion information extraction unit configured to extract motion information within the image for the detected object;
an object number change rate measurement unit configured to measure an object number change rate within the image for the detected object;
an entropy calculation unit configured to convert a position change rate of the object, measured based on the position information, a motion change rate of the object, measured based on the motion information, and the object number change rate into energy information, and measure entropy of the converted energy information; and
a situation recognition unit configured to recognize a situation within a space where the image was taken by associating a change rate of the entropy measured within the image with a risk policy.

2. The situation recognition apparatus of claim 1, wherein the object detection unit detects multiple objects, and
the entropy calculation unit converts the position change rate, measured for the multiple objects, and the motion change rate, measured for each of the objects, into the energy information.

3. The situation recognition apparatus of claim 1, further comprising a weight applying unit configured to apply a weight to one or more of the position change rate of the object, the motion change rate of the object, and the object number change rate,
wherein the entropy calculation unit measures the entropy based on the weight.

4. The situation recognition apparatus of claim 3, wherein the weight applying unit applies the weight based on a reference value stored in a database for each environment in the space where the image was taken.

5. The situation recognition apparatus of claim 3, further comprising a normalization unit configured to normalize the position change rate of the object, the motion change rate of the object, and the object number change rate and transmit the normalized rates to the weight applying unit.

6. A situation recognition method using object energy information, comprising:
receiving a taken image;
detecting an object by analyzing the received image;
extracting position information within the image for the detected object;
extracting motion information within the image for the detected object;
measuring an object number change rate within the image for the detected object;
converting a position change rate of the object, measured used on the position information, a motion change rate of the object, measured based on the motion information, and the object number change rate into energy information, and measuring entropy of the converted energy information; and
recognizing a situation within a space where the image was taken by associating a change rate of the entropy measured within the image with a risk policy.

7. The situation recognition method of claim wherein the detecting the object comprises detecting multiple objects, and
the measuring the entropy comprises converting the position change rate measured for the multiple objects and the motion change rate measured for each of the objects into the energy information.

8. The situation recognition method of claim 6, further comprising applying a weight to one or more of the position information rate of the object, the motion change rate of the object, and the object number change rate,
wherein the measuring the entropy comprises measuring the entropy based on the weight.

9. The situation recognition method of claim 8, wherein the applying the weight comprises applying the weight based on a reference value stored in a database for each environment in the space where the image was taken.

10. The situation recognition method of claim 8, further comprising normalizing the position change rate of the object, the motion change rate of the object, and the object number change rate, and then applying the weight.
